(19) United States
(12) Patent Application Publication
(10) Pub. No.: US 2005/0124320 A1
(43) Pub. Date: Jun. 9, 2005

(54) System and method for the light-weight management of identity and related information

(76) Inventors: Johannes Ernst, Sunnyvale, CA (US); Tammy Ernst, Sunnyvale, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/008,523

(22) Filed: Dec. 8, 2004

Related U.S. Application Data
(60) Provisional application No. 60/528,450, filed on Dec. 9, 2003.

(51) Int. Cl. H04M 3/16

(52) U.S. Cl. 455/411

(57) ABSTRACT

A distributed system and a method is disclosed for managing, and making available electronically, a plurality of evolving identity and other information of a variety of human and non-human actors, for human and machine use. A computer implemented distributed system and method is also disclosed for managing, and making available electronically, a plurality of evolving identity and other information for a variety of human and non-human actors, for human and machine use.

### PRIORITY CLAIM

This application claim priority under 35 USC 119(e) to U.S. Patent Application Ser. No. 60/528,450 filed on Dec. 9, 2003 entitled “System and Method for the light-weight management of identity and related information” which is incorporated herein by reference.

### FIELD OF THE INVENTION

This invention relates generally to a distributed system and method for managing and making available electronically a plurality of evolving identity and other information of a variety of human and non-human actors, for human and machine use. The invention relates in particular to a computer implemented distributed system and method for managing and making available electronically a plurality of evolving identity and other information for a variety of human and non-human actors, for human and machine use.

### BACKGROUND OF THE INVENTION

Since the advent of bureaucracy, but certainly since the advent of electronic data management, “digital identities” have proliferated. For the purpose here, we define a “digital identity” as a token of information (of any size) that identifies, or contributes to identifying, and potentially to authenticating, an actor within a certain context. Actors can be human individuals, non-human agents, other entities (e.g. organizational entities such as corporations, partnerships, or families) or roles played by any of them. The context is usually provided by the identity-issuing authority (the “identity authority”) and, potentially, also comprises a network of other entities that accept the same digital identity. Identities can be unique, i.e. a digital identity uniquely identifies an actor within the context; or they can be non-unique, i.e. a digital identity narrows the set of potential actors it identifies to size 2 or larger but does not select a unique member of the set. Identities can be intended to be used publicly, or only privately with one or few other parties.

There are many examples of digital identities: US social security numbers are unique identities issued by the US Social Security Administration for individuals, but they are accepted more broadly. Phone numbers are digital identities for individuals or organizations (e.g. families or businesses), issued by a phone company, and accepted worldwide through a series of bilateral and multilateral agreements both within countries and internationally. A phone number may be unique (e.g. if only one and the same actor answers the same phone, ever), or non-unique (e.g. if any of a number of family members may answer the shared phone in the house). Further, it may identify uniquely, or non-uniquely, an individual, an organization (such as a company, family etc.) or a role (e.g. tech support for company X). They may also identify non-human actors, such as software applications, software components, information components, websites, devices, processes and other items. Other digital identities are e-mail addresses (typically unique), URLs for personal web sites, instant messaging handles, handles in and for certain on-line services and websites, account numbers, street addresses (typically non-unique) and many more. Some of them, like an actor's first and last name, are typically considered public, while others, such as a credit card number or bank account number, are expected to be non-public.

Today, many actors have not only many digital identities, but often multiple digital identities within the same category of identity: for example, many individuals have multiple e-mail addresses (sometimes to separate business from personal e-mail, but often just for historical reasons), multiple instant messaging handles (e.g. on different instant messaging networks), multiple physical addresses (home, office, vacation home, temporary address on a business trip, shipping address etc.) and multiple phone numbers (e.g. home, 2^{nd} home line, office direct, office through secretary, office through receptionist, when at branch office, cell phone, cell phone when traveling internationally, fax at home, fax at work etc.). When we count frequent flyer membership numbers, credit card numbers, customer numbers, frequent shopper numbers, account names at various websites and so forth, the list of digital identities is increasingly becoming unmanageably long for virtually anyone. If recent history is any guide, the length of the list of identities for one single actor will keep on growing exponentially as new products, services and business relationships are invented and brought to market, as actors become more mobile, and as new electronic communication modes as well as communication and collaboration-related products and services proliferate.

At the same time, however, a typical actor's average loyalty to identity-issuing authorities is decreasing, thereby creating a need to support evolving digital identities, i.e. digital identities whose number and information content changes over (brief, or long periods of) time. The merger, closure, or renaming of identity-issuing authorities causes the need for further changes. Changing e-mail addresses, changing instant messaging handles, changing cell phone numbers and changing web site URLs have become common. For example, attempting to reach a business acquaintance by phone several years after the last conversation has become virtually impossible: phone numbers are typically allocated by geography, by service provider, and, in case of a business phone number, by employer. As soon as the individual moves, changes employers or their phone company splits an area code into two, their phone number (a digital identity) becomes unusable. Forwarding mechanisms exist only in the most rudimentary fashion today, if they exist at all, and generally do not work beyond a fairly short amount of time, often less than one year.

This situation poses several significant problems:
How does an actor publish their digital identities to those parties that need them? (Example: “how do I publish my current cell phone number to everyone who may want to reach me on my cell phone?”)
How does an actor publish changes of their digital identities to those parties who may otherwise attempt to use outdated ones? (Example: “how do I notify everyone that my e-mail address has changed?”)
How does an actor manage his or her own list of digital identities? (Example: “which user name did I choose for the website of the New York Times?”) A solution to this issue should be capable of managing those digital identities in a manner that makes authentication transparent to the user (“single sign-on”) while also guaranteeing certain privacy and security qualities.
How does an actor manage the digital identities of those parties with whom they regularly need to interact? (Example: “which phone number do I need to call this afternoon to reach John Doe, who recently changed employers and travels often?”)
How does an actor ensure that their digital identities are only made available to those parties who should have them? (Example: “Other members of my kids' parent-teacher association can have my home phone number, but my business associates can not.” Or: “How do I make sure that only my bank's website has knowledge of my password at that site, and nobody else?”)
How do communication devices (as well as other software and hardware that make use of digital identities) obtain the (most suitable) digital identity of the actor that needs to be contacted, prior to attempting to contact them? For example, how does my phone know the right number to dial if I want to talk to my acquaintance Joe? Do I need to look him up in my address book, find the number and re-type it on the keyboard of the phone? Or, given the current time, schedule and other circumstances (e.g. because Joe is in a meeting), should my phone attempt to contact Joe via instant messaging instead of a voice call instead?

Several technologies have been proposed in the past to address some of these issues, but they all have substantial shortcomings:
E-mail “VCard” attachments (as standardized by the Internet Engineering Task Force as RFC 2426 , for example; however, this argument applies to any comparable set of information attached to e-mail as well as similar information attachments to any other communication mode) can be used to attach certain digital identity information (such as physical address, phone numbers, e-mail addresses, etc.) of an actor to every e-mail sent by that actor. However, they do not sufficiently address the above requirements because:
1. They can only be sent and received through a small subset of the required communication modes (e.g. e-mail attachments will not automatically be received by the receiver's home phone)
2. The likelihood of having only out-of-date information increases with the length of time since the last successful e-mail exchange between the parties. Thus, this approach does not address the long-lost acquaintance problem.
3. By themselves, they are insufficiently integrated with the information management and use needs of either party or the technology either party uses to manage or use them. For example, they are not typically integrated with a company's sales lead management system.
4. In practice, they are unable to send different information to different receivers, as it would be advantageous for privacy, security and convenience reasons.
5. They do not lend themselves as a mechanism for confidential digital identities (e.g. bank account numbers), as all represented information is generally visible to everyone.
6. They generate a large amount of unnecessary data traffic between individuals who communicate frequently.
Certain on-line directories hosted by certain service providers (e.g. Microsoft Passport, AOL, white/yellow pages providers, Plaxo and competitors, certain “social software“ providers, digital identity providers such as Liberty Alliance supporters, some employers etc., who, for a variety of reasons, are a rather exclusive club), as well as the specifications of identity consortia (e.g. Liberty Alliance). Their main problems for the set of requirements discussed here are:
1. The actor's digital identity information is under the control of the service provider (or consortium of service providers), not of the actor. As digital identity information may include financially sensitive account information, for example, this approach often evokes fierce consumer resistance and is thus not feasible for many applications.
2. The actor's digital identity information becomes unavailable publicly as soon as the actor ceases using their particular directory service from a particular service provider. Switching to a competing service provider is generally not possible without severe interruption of service for the (human, or machine) consumers of the switcher's identity-related information.
3. The actor's digital identity information becomes unavailable as soon as the service provider changes business models or policy, goes out of business, etc.
4. The digital identity information that can be managed is limited to the information content foreseen and desired by the service provider. In practice, the supported information content is determined mainly by the business agenda of the service provider, and not necessarily by the needs of the user. For example, a service provider also offering an instant messaging network may not allow the actor to specify and publish an additional instant messaging handle of a competing instant messaging provider, for obvious reasons. Conversely, the actor cannot innovate in terms of which identity-related and other information they would like to provide electronically, nor in terms of software behavior, without the service provider's consent. Even with the consent, the technical obstacles to innovation in this scenario would be formidable.
5. Integration of the on-line information into the communications and other tools used or needed by the user for communication, or other uses of digital identities, is difficult, or non-existent, leaving the user to manually “bridge the gap”. For example, the user may have to “manually look up” certain identity information, and then re-type the found identity information into the application where it is needed (e.g. phone number found on an AOL profile).
6. They focus on the needs of identity issuing organizations and their affiliates (which mostly are to conduct more, and more efficient business), rather than the needs of the individuals, groups and organizations owning their digital identities.
7. They require a substantial amount of technology to implement (e.g. a full web services infrastructure), thereby making it all but impossible that individuals can manage and “own” their own digital identities with minimal incremental cost.
The technology developed by the Friend-Of-A-Friend (“FOAF”) Project can be used by individuals and organizations to publish identity-related information about themselves and their friends to machine clients that support the XML RDF format. However:
1. It does not allow the actor to selectively publish certain identity information to some clients, but not others.
2. They do not lend themselves as a mechanism for confidential digital identities (e.g. bank account numbers), as all represented information is generally visible to everyone.
3. Integration of the on-line information into the communications and other tools used or needed by the user for communication, or other uses of digital identities, is difficult, or non-existent, leaving the user to manually “bridge the gap”. For example, the user may have to “manually look up” certain identity information, and then re-type the found identity information into the application where it is needed (e.g. phone number found on an AOL profile).
4. Extensibility, and decentralized innovation is difficult as the FOAF technologies are centered around a particular file format that cannot be easily extended by multiple parties without broad consensus on the extensions, without breaking older implementations.

Further problems exist that apply to a number of the existing alternatives:
1. Digital identity-related information as it is managed today is often not accessible and interpretable by machines: if it were, that would benefit internet client software/hardware/devices as well as embedded applications (e.g. a stock alert notification agent could automatically look up an actor's correct notification phone number for this place/time).
2. An important reason for it not being accessible by machines is that either publicly documented APIs do not exist that can be used by machines or because those APIs cannot be accessed by arbitrary software across the network. Even where published APIs exist, they are often prohibitively complex (one of the reasons for the present invention).
3. Actors cannot easily manage their identity information centrally: the whole world has more or less out-of-date copies of certain aspects of the actor's identity information. Global updates are often so hard as to be essentially impossible.
4. It is difficult or impossible to provide different information to different audiences.
5. These mechanisms do not have the ability to provide real-time updates or “annotations” to identity information, so highly valuable real-time requests for digital identities like “give me the phone number of this individual at his current location” cannot be performed.

Thus, it is desirable to provide a system and method for the light-weight management of identity and related information that overcomes the limitations of the conventional systems and solution and it is to this end that the present invention is directed.

### SUMMARY OF THE INVENTION

The present invention includes the following features and benefits:
Every individual, group or organization, be it human or non-human, (called an actor) with a “conceptual identity” has the ability to centrally manage all of their digital identities.
However, there is no need to manage all the digital identities of (several, or many) actors in the same location, such as by the same digital identity provider or internet service provider. While central management of several actors' digital identities by the same digital identity provider is certainly possible when employing the present invention, and while such central management sometimes may be advantageous, it is not required; in the normal case, the digital identities of actors are managed in many different, distributed locations, making a system according to the present invention a distributed and fully decentralized system. The only centralization requirement imposed by the present invention is the location of all the information about any given actor's identity; and even that can be distributed in a different embodiment of the present invention, using industry-standard synchronization and replication technologies and, for example, Uniform Resource Names (URNs) as the actor URIs (see below), instead of the Uniform Resource Locators (URLs).
The actor has the ability to choose freely the location of this (from the perspective of the actor) centrally managed place for their own digital identities. This location is identifiable by a Uniform Resource Identifier (URI) that may be transportable between service providers, such as Internet Service Providers and even Domain Name Registrars. This URI is the point of entry into the “aggregation” all digital identities of the actor.
By using the concept of a URI, the context of the digital identity enabled through the present invention is global.
Certain software (a “request handler”) manages services at this URI. In particular, it responds to incoming requests from another actor (the “client”) and/or other software for one or more digital identities, and/or identity-related information at that URI.
The request handler responds to the request with the information that is appropriate based on the request, the available information, the security policies in effect, and based on the identity of the client requesting the information.
It allows different responses to requests, in real-time, depending on information held externally to the system. For example, the request handler may return a different preferred phone number depending on the time of day, the actor's current location or their schedule (as determined from a calendar management or work order system, for example). That way, arbitrarily complex response behaviors are possible without a change in the principles and standards needed for the operation of the system.
There are a number of access methods and parameters to the request handler, eliciting different responses. The access methods permit a variety of invocations with a variety of input parameters that can be performed on this URI, enabling the system to manage and provide complex information in return.
The request handler may also respond to requests for information that is not directly identity information through the same interface. For example, the request handler may respond to a query for the actor's favorite news story of the day, the airline seat preference, or the name of the music file currently listened to by the actor, or all or some content of the actor's weblog. For the purposes of the present invention, we call this kind of information “identity-related information”.
The request handler can suitably respond to requests from humans, and from machines. For example, for humans it may return the result of the request in HTML, for machines in XML or other suitable formats.
The needed conventions and protocols for the present invention are seamlessly integrated into today's web infrastructure and are immediately usable and useful with industry-standard clients (e.g. web browsers) and servers (e.g. web servers).
Certain results of queries may cause an automatic redirection to other URIs. For example, a request for an e-mail address may automatically redirect to a URL using the mailto: protocol.
The requests sent to the request handler and its responses can be expressed in a simple-to use standard query format that can be implemented and supported widely by machines large and small, and can even be typed into a browser as part of a URL by average users.
The actor has full control over both the content that may be returned in response to an incoming request, and the implementation and configuration of the request handler that does so. Many different organizations and individuals can deliver interoperable implementations of the request handler as well as making compatible extensions, agreeing on nothing more than the principles and spirit of the present invention, thereby making the present invention a platform for innovation.
No double entry of digital identity information is necessary. Neither the owner of digital identity information nor the consumer of digital identity information has that need.
The request handler can be implemented in different ways that nevertheless conforms to the present invention and that are interface-compatible (i.e. client software does not depend on the particular implementation). In particular:
1. The request handler can be implemented in a way that allows the operation of the request handler at virtually all of today's typical internet service providers offering the ability to run scripts, without needing the internet service provider's active cooperation. Deployment may be as simple as installing a single, simple and self-contained Common Gateway Interface (CGD) script for a web server and as little as one data file.
2. The request handler can be implemented in a way that allows the request handler to be hosted and operated as a managed service by 3^{rd}-party operators for their clients.
3. The request handler may be implemented as an additional feature for other types of software, such as directory systems, e-mail management systems, collaboration systems, document management systems, calendaring systems, social software systems, customer relationship management and trouble-ticket systems, and others.
A large variety of identity management/authentication systems can be used as an authentication mechanism for clients of the request handler against the request handler. This allows the request handler to securely provide different information to different clients, depending on the client, and/or on which group a given client belongs to.
Software developers developing applications that can take advantage of digital identity-related information can use this invention to reduce complexity of their products while increasing functionality: instead of managing phone numbers in speed dial lists, instant messaging handles in buddy lists, full customer address information etc., and increasingly trying to integrate those, they can simply manage a single URI for one individual or other actor, and look up always-current digital identity information when it is needed.

Information can be provided both for actors and for roles. For example, a company may set up such a URI for their CEO, which remains the same URI even if one CEO leaves and another one joins.

Thus, in accordance with the invention, an identity management system is provided. The identity management system comprises one or more first computers that connect to a second computer over a network wherein each first computer further comprises an application that generates a request for identity information about an actor, the request being communicated to the second computer over the network. The second computer further comprises a request handler that receives the request, a data file containing one or more pieces of information about the identity of the actor and an authorization file containing information about the authorization level for each piece of information wherein the request handler automatically generates an identity response containing identity information in response to the request based on the data file and the authorization file.

In accordance with yet another aspect of the invention, a method for identity management is provided. In a first step, a request for identity information about an actor is generated at a first computer and the identity information request is communicated to a second computer. At the second computer, an identity response in response to the identity information request is automatically generated wherein the identity response is generated based on a data file containing one or more pieces of information about the identity of the actor and an authorization file containing information about the authorization level for each piece of information.

### BRIEF DESCRIPTION OF THE DRAWINGS

FIG. 1A is an example of a preferred embodiment of a computer-implemented single-actor identity management system in accordance with the invention;

FIG. 1B is an example of another embodiment of a computer-implemented single-actor identity management system in accordance with the invention;

FIG. 2 illustrates further details of the client computer shown in FIG. 1;

FIG. 3 illustrates further details of an alternate embodiment of the client computer in FIG. 1;

FIG. 4 illustrates an example of a preferred embodiment of the request handler in FIG. 1;

FIG. 5 illustrates an example of a preferred authenticated callback method in accordance with the invention;

FIG. 6 illustrates an example of a preferred embodiment of the data file 107 shown in FIG. 1;

FIG. 7 illustrates an example of a preferred embodiment of the authorization file 108 shown in FIG. 1;

FIG. 8 illustrates an example of a preferred embodiment of the request 102 shown in FIG. 1;

FIGS. 9A-C illustrate an example of a preferred embodiment of the response 109 shown in FIG. 1;

FIG. 10 illustrates another embodiment of a computer-based identity management system in accordance with the invention that incorporates a third party; and

FIGS. 11-1 to 11-4 are diagrams illustrating the behavior of the identity management system in accordance with the invention as a single sign-on system.

### DETAILED DESCRIPTION OF THE PREFERRED EMBODIMENT

The invention is particularly applicable to a software based, computer implemented identity management system and it is in this context that the invention will be described. It will be appreciated, however, that the system and method in accordance with the invention has greater utility as the system may be used to manage various other forms of information and may be implemented is different manners that are within the scope of the invention.

A preferred embodiment of the invention is implemented in software using the Practical Extraction and Report Language (Perl) programming language. However, as it will become apparent from this description, those skilled in the art will be able to embody the present invention in many different ways, in a centralized or decentralized manner, using files or databases, other computer languages and programming systems or even directly in hardware. Furthermore, different network protocols, web services, information schemata, data representation approaches, query languages etc. can also be used without deviating from the principles and the spirit of the present invention.

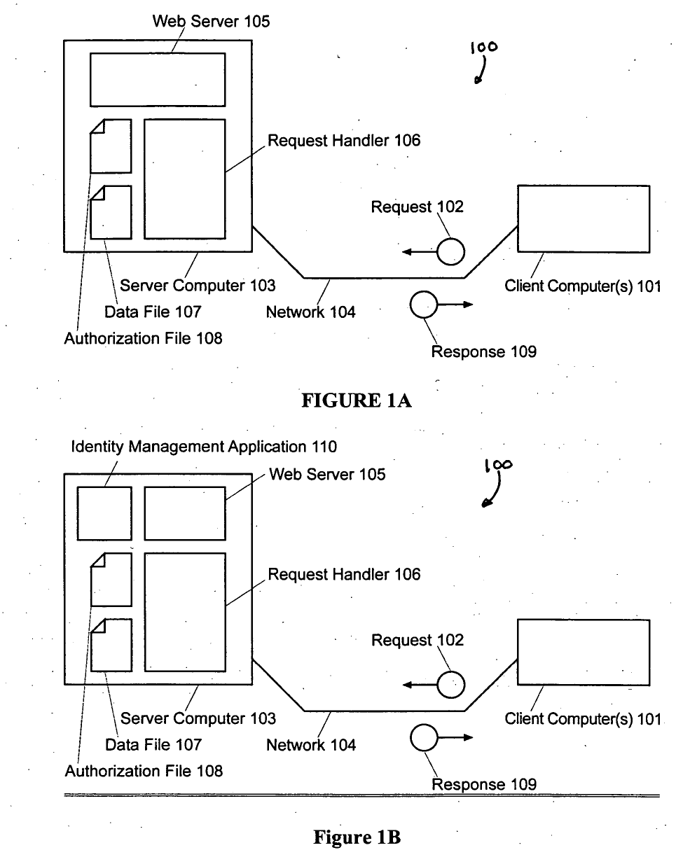

The preferred embodiment of the present invention for a single, main actor will be described using FIGS. 1 through 10 as well as FIGS. 11-1, 11-2, 11-3 and 11-4. An embodiment of the identity management system for multiple main actors is straightforward for those skilled in the art (and could be easily implemented without undue experimentation based on the disclosure in this document) and thus does not need to be described.

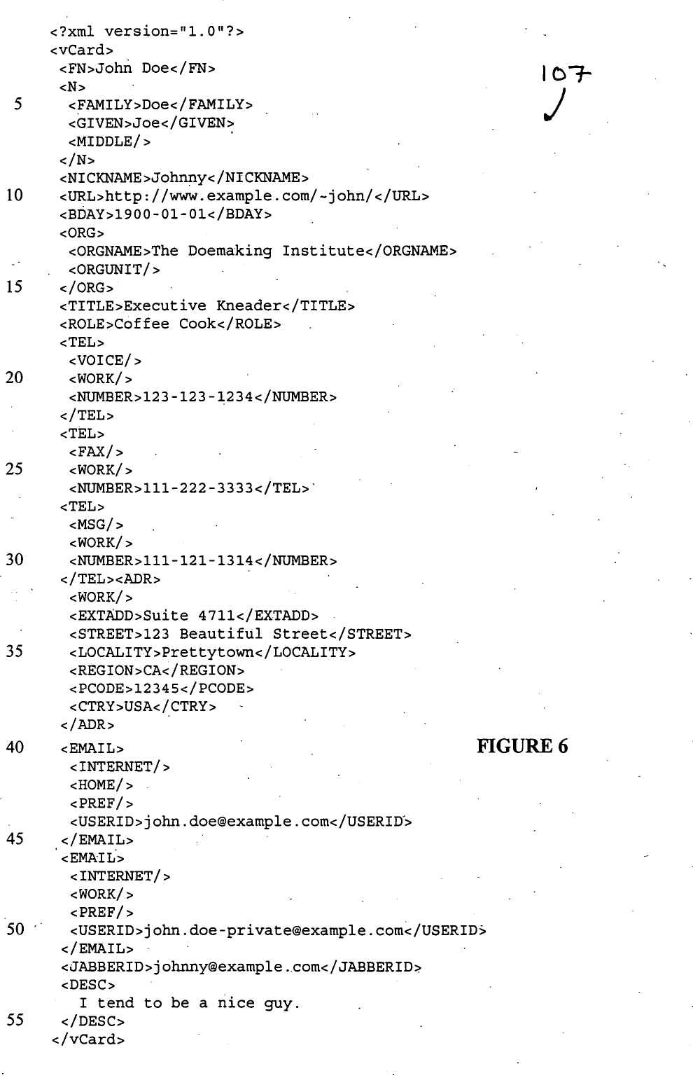

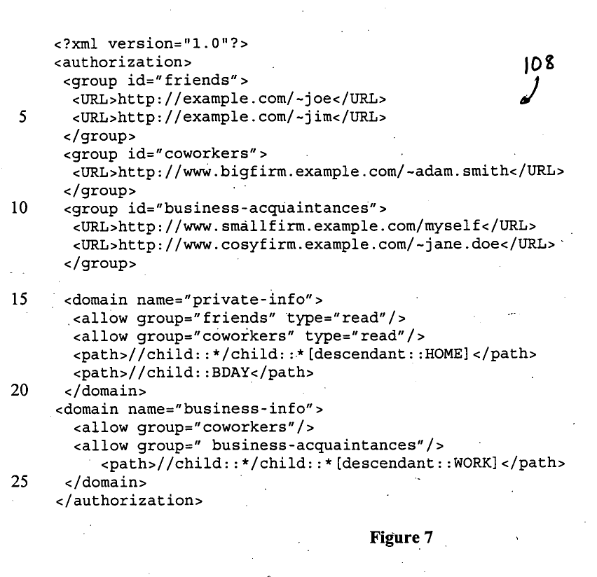

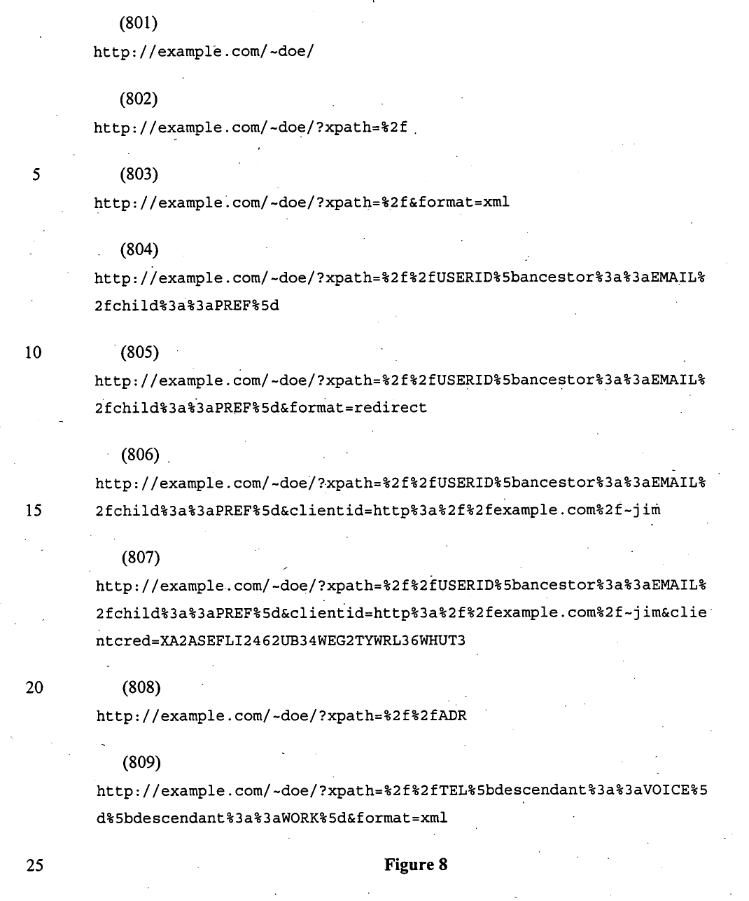

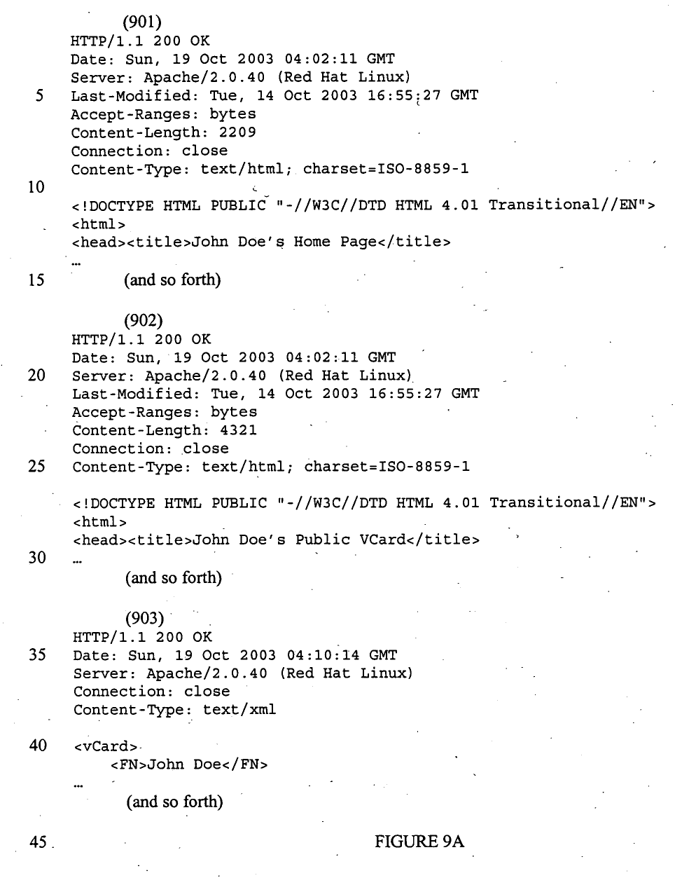

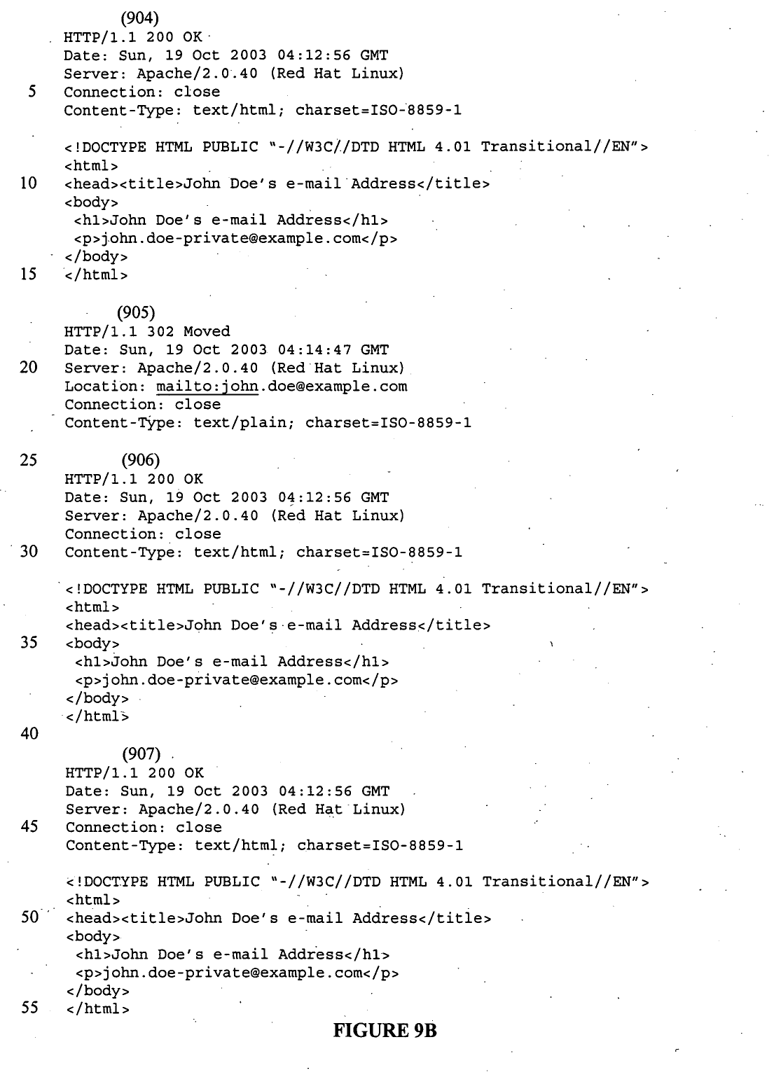

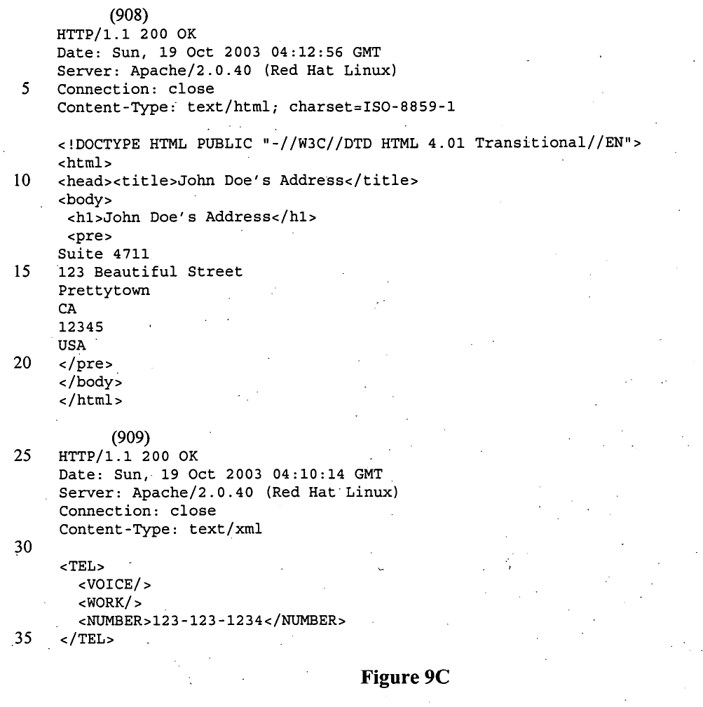

In FIG. 1A is an example of a preferred embodiment of an identity management system 100 for a single action in accordance with the invention that comprises one or more client computers 101 that send one or more requests 102 to a server computer 103 over one or more networks 104 such as the internet, a wireless connection, a wired connection, a bus system or any other data network or connection. The requests 102 are handled by a typical web server or application server 105, running on the server computer 103. In a preferred embodiment, each module or application on the server computer is a software application that is stored in the memory of the server computer and executed by the processor(s) of the server computer. The web server 105 delegates the request 102 to a request handler 106, which, in the preferred embodiment, is a Common Gateway Interface program written in the Perl programming language. This request handler 106 processes the request 102 (an example of which is shown in FIG. 8), consulting with a data file 107 (an example of which is shown in FIG. 6) and with a authorization file 108 (an example of which is shown in FIG. 7), and responds with a response 109 (as example of which is shown in FIG. 9) to the client computer 101, via the web server 105, the server computer 103 and the network 104. An identity management application 110 running on the server computer 103 may be used by the owner of the digital identities in data file 107 to create and change the information held by data file 107 and authorization file 108.

In the preferred embodiment of the invention, client computers 101 and server computer 103 are one or more of the following, in any combination:
1. A Personal Computer;
2. A Server Computer;
3. A handheld or wireless computer;
4. A mobile device, such as a cell phone;
5. An embedded device, such as an embedded control unit, smart card, RFID card or other embedded device; and/or
6. Any other general-purpose or special-purpose computing device that has sufficient computing resources and power (e.g., processor speed, memory space, etc.) to perform the functions and operations of the server computer 103 and client computer 101, respectively.

In the preferred embodiment of the invention, request 102 is one of the following:
1. An HTTP GET request with zero or more of the following, optional, parameters and parameter values:
xpath: a properly escaped XML XPath expression describing the information that client wishes to obtain from data file 107. A properly escaped expression, text string, etc. is a string of characters in which certain characters in the string have been replaced when the certain characters are not permitted within the string. If the xpath parameter is missing in the request, a default response will be sent, such as a redirect to the URL of the actor's home page specified in data file 107, to another default page, or any other default information.
format: one of an enumerated value domain of return formats. The domain for the enumerated value includes 1) “HTML” (provide response in human-readable HTML format), 2) “XML” (provide response in machine-readable XML format as XML file, or XML fragment), 3) “redirect” (respond with an HTTP redirect if the return data is a URL to which an HTTP redirect is possible; HTML otherwise), 4) “meta” (provide response in machine-readable XML format that lists the possible requests) 5) “management” (provides access management functionality), 6) other values, indicating non-standard operations and/or formats that client and server agree on. If this parameter is missing, a default format is used, taking the acceptable formats parameter into account that HTTP clients send to HTTP servers.
clientid: a properly escaped uniform resource identifier (URI) identifying another actor (called the “client actor”) who sends the request, or on whose behalf the request is sent.
clientcred: a properly escaped text string that represents a credential that the client actor supplies, as part of the request, in support of the presented clientid.
clientcredtype: a properly escaped text string that indicates the type of credential that is being presented.
clientauthority: a properly escaped URI identifying an authority that can validate the clientcred.
2. An HTTP POST request, carrying the same information as in case #1.
3. A combination of case #1 and case #2, where some or all parameters are passed as arguments to the URL, and some or all are provided as part of the HTTP POST, and some or all are provided as HTTP Cookies.
4. Any one of case #1, #2 and #3 where the HTTP communication is encrypted, such as using the HTTPS protocol (all such approaches will be called HTTPS from here, for simplicity reasons). In this as in some other cases, part of the information does not need to be transmitted as it may be able to be inferred. For example, authentication may have been performed already as part of setting up the encrypted connection.

As those skilled in the art will know, an equivalent request containing substantially the same information content can be submitted using a variety of other protocols, such as SOAP, XML-RPC, CORBA, Java/RMI, DCOM, e-mail, instant messaging and many others, encrypted or not, without deviating from the principles and the spirit of the present invention.

In the preferred embodiment of the invention, response 109 is one of the following:
1. A human-readable HTML document with the requested information.
2. A human-readable HTML document with an error message and a suitable HTTP status code indicating an error.
3. A human-readable HTML document with the requested information, and in-lined XML with all or part of the requested information.
4. A machine-readable XML file with the requested information.
5. An XML fragment with the requested information.
6. A machine-readable XML file or fragment with error code.
7. An empty response with an HTTP status code indicating an error.
8. An HTTP redirect response, redirecting the client to a new URI. This new URI may be a URI identifying another type of communication mode, such as e-mail (using the mailto: tag) or any other standard or non-standard URI.
9. Any or all of the above responses in encrypted form.
10. Any and all combinations of the listed responses.

The requested information being returned in response 109 may be, but is not limited to, one of the following. Some examples require request handler 106 to interact with other information or other systems that, by themselves, are not part of the present invention. The response 109 may contain one or more of the following:
1. A VCard, or the information held by a VCard in XML format.
2. A FOAF file, or the information held by a FOAF file. (To simplify the comprehensibility of this document, from here, we will call FOAF as well as other information similar to the information held by a VCard VCards as well).
3. Any simple element from a VCard, such as the last name.
4. Any compound element from a VCard, such as the name comprising first, middle and last name.
5. A set of elements from a VCard, such as all contained addresses.
6. A set of qualified elements from the VCard, such as all the work addresses.
7. VCard or other information expressed in XML, and/or RDF or any other structured information format.
8. Information expressed in RSS (Resource Syndication Format), an extension of RSS, Atom, an extension of Atom, or any other similar format.
9. A redirect to a new URI, such as a home page, email address, instant messaging conversation, message board or any other type of URI.
10. Non VCard identity-related information, such as high school and graduation date.
11. Other information, such as the actor's hobbies.
12. Other non-static information, such as the actor's song of the day.
13. Any information from a database (e.g. restaurant evaluations performed by the actor, or made available by or referred to by the actor).
14. Information from another application, such as the actor's calendar.
15. Information generated on demand, such as a picture from a camera. In this case, additional information may be provided by client computer 101 in request 102 that configures a remote information acquisition or telemetric device (in case of a camera, for example, it may be viewing angle, lens focal length etc. that will cause the camera to perform certain actions prior to obtaining the requested information).
16. The actor's current location.
17. The actor's past location.
18. The actor's current “presence” state, such as “on the phone”, “busy”, or “available”, with or without qualifying information such as which subjects the actor is currently occupied by.
19. Passwords and other credentials held or known by the actor.
20. The actor's public key, or other public keys known by the actor.
21. The actor's bank account information, or other financial information, or such information known by the actor.
22. The actor's tax identification, or such information known by the actor.
23. Information tokens identifying value, such as electronic representations or transactions of money.
24. Information about the actor's relationship or relationships to other actors, such as whether the actor know other actors, endorses other actors, or other social network relationships.
25. Any and all combinations of the listed kinds of information, whether it is known statically, or dynamically created or obtained when queried.
26. Other information.

The actual information, which is all considered identity information for the purposes of the present invention, that is sent may depend on the identity of the client, the current time, the location of the actor and/or the client, the current “presence” state of the actor and/or the client, the actor's calendar or many other items of external information.

FIG. 1B shows a different embodiment of the system 100 wherein the server incorporates an identity management application 110 (a piece of software/software module(s) in a preferred embodiment) that can be accessed by client computer 101 using network 104. In the preferred embodiment, identity management application 110 is accessible at the same URI as request handler 106 and invoked by request handler 106 when provided with a special parameter “management=true”. The identity management application 110 comprises a software application that generates a plurality of user interface screens which require the actor to provide credential information prior to accessing them, such as through a username and password that is installation-dependent. Through the plurality of screens comprising the identity management application 110, the actor can:
create and modify data file 107.
create and modify authorization file 108.
approve or deny incoming identity requests 102, thereby causing different responses 109 to be sent.
manage the rules that determine the responses 109 of request handler 106 for incoming requests 102.

As those skilled in the art will recognize, the identity management application 110 may also be implemented using different technologies without deviating from the principles and spirit of the present invention.

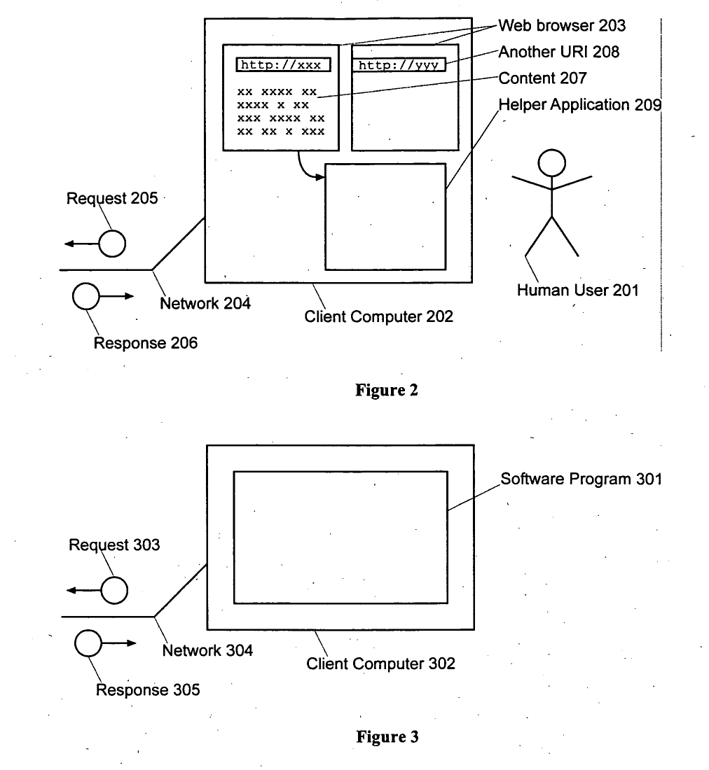

FIG. 2 shows a human user 201 using the client computer 202, which is the same as client computer 101 in FIG. 1. Here, the human user 201 interacts with a web browser 203 that runs on the client computer 202 and that interacts with the network 204, which is the same as network 104 in FIG. 1. Human user 201 causes web browser 203 to send a request 205, which is the same as request 102 in FIG. 1. Web browser 203 sends the request 205 to server computer 103, as shown in FIG. 1, using the HTTP protocol (or another protocol, as was described previously, in clear text or encrypted) and receives the response 206, which is the same as response 109 in FIG. 1. Depending on the content of response message 206, web browser 203:
Displays the content 207 of the response message 206, or
Is redirected to another URI 208, or
Invokes a helper application 209 (such as a PDF document viewer, rich text viewer, Spreadsheet viewer, address book or other application) on the client computer 202 or another computer or computing device.

In the preferred embodiment of the invention, human user 201 causes web browser 203 to send the request 205 using one of the following methods:
1. User enters the full URI constituting the request into the web browser.
2. User clicks on a URL contained in another web page that redirects the browser to the URI constituting the request.
3. User fills out a form whose submission causes the request to be sent.
4. User selects the full URI constituting the request from a bookmark, or similar mechanism.
5. User performs an action in another software program on client computer 202, or any other computer, that causes web browser 203 to send the request, directly or indirectly.

As those skilled in the art will know, web browser 203 does not strictly (or exclusively) need to be a web browser without deviating from the principles and spirit of the present invention as the web browser 203 could also be an e-mail client, instant messaging client, or any other piece of software supporting the notion of URIs and/or the HTTP protocol or other protocol, whether or not these notions are visible to the end user.

FIG. 3 shows an alternate embodiment of part of the invention, in which software program-301 runs on the client computer 302, which is the same as client computer 101 in FIG. 1. Here, software program 301 sends a request 303, which is the same as request 102 in FIG. 1, over a network 304, which is the same as network 104 in FIG. 1, and receives a response 305, which is the same as response message 109 in FIG. 1. Depending on the content of response 305, software program 301 performs a different action.

In this alternate embodiment of the invention, software program 301 is one or more of the following:
1. Application software;
2. Infrastructure software;
3. Embedded software;
4. Software implemented in hardware;
5. A software agent that monitors certain information;
6. Downloaded software such as applets, web page scripts etc; and/or
7. Any other software that has the need to contact an actor at some time, either autonomously, or on behalf of some other software or a human user.

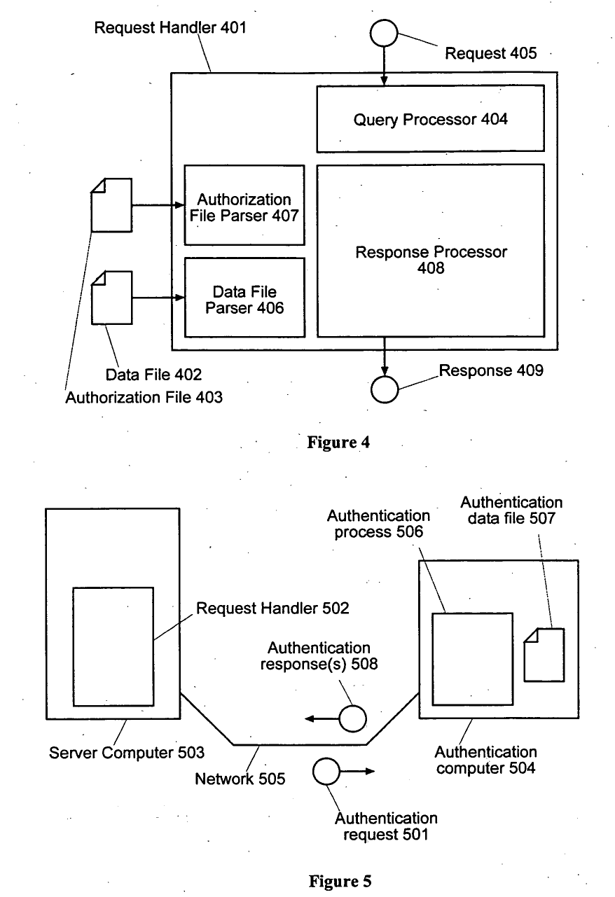

In FIG. 4, an overview is given of a request handler 401, which is the same as request handler 106 previously shown in FIG. 1, and a data file 402, which is the same as data file 107 previously shown in FIG. 1, and an authorization file 403, which is the same as authorization file 108 previously shown in FIG. 1. In a preferred embodiment, each element of the request handler 401 is a software application/piece of software code that is executed on a computer. The request handler 401 consists of a query processor 404, which parses the incoming request 405, which is the same as request 102, previously shown in FIG. 1. It further consists of a data file parser 406, which parses data file 402. It further consists of an authorization file parser 407, which parses authorization file 403. It further consists of a response processor 408, which relates the information found by query processor 404, data file parser 406, and authorization file parser 407, and produces a response 409, which is the same as the response 109 previously shown in FIG. 1.

In the preferred embodiment of the invention, data file 402 is an XML file containing VCard-type information. However, as those skilled in the art will recognize, data file 402 may also be one or a combination of the following without deviating from the spirit and principles of the present invention:
One or more XML files containing extended VCard information, extended by standard or non-standard elements.
One or more XML files containing any other type of information related to digital identities, or any other information, using one or more standard or non-standard document types.
One or more databases or other information repositories presenting or making accessible their content, or part of their content, as XML stream or XML document object model.
One or more files, memories, databases or other information repositories presenting their content, or part of their content, in a manner so that individual information items, or groups of information items, can be addressed using XPath or other navigation and selection expressions.
One or more files, memories, databases or other information repositories presenting their content, or part of their content, in a manner so that individual information items, or groups of information items, can be addressed using tags or queries.

In the preferred embodiment of the invention, authorization file 403 is an XML file containing authorization information. However, as those skilled in the art will recognize, authorization file 403 may also be one or a combination of the following without deviating from the spirit and principles of the present invention:
One or more other files containing authorization information.
One or more databases or other information repositories containing authorization information.
One or more web services enabling the querying of authorization information from one or more remote systems.

Regardless of its actual syntax or structure, authorization file 403 contains information representing one, more than one, or all of the following concepts:
A digital identity of a client actor.
An algorithm, or reference to an algorithm, and/or information enabling the response processor 408 to determine whether or not a given identity of a client actor matches or does not match, whether it may or may not be trusted.
The grouping of client actors into “groups of client actors” (including the special case of single-member groups).
The specification of information elements in data file 402, using concepts such as XPaths, individual identities of information elements, or other mechanisms that identify information elements or groups of information elements in data file 402.
The concept of a protection domain, which collects one or more information items.
The digital identities of trusted providers of authentication.
Information for which clientid, or any other criteria, authentication is not required.
Client credential information (such as passwords, encrypted passwords, public keys etc.) used for local authentication.
The relationship between groups of client actors and protection domains, identifying which types of access (e.g. create, read, update, delete) is granted to which groups of client actors for which protection domains.

In the preferred embodiment of the invention, data file parser 406 and authorization file parser 407 are one or more of the following:
An XML parser.
A parser for the data file and/or authorization file format.
An Applications Programming Interface that can access the information held in data file or authorization file in response to a request from the response processor 408.

In FIG. 5, another aspect of the present invention is shown that provides an authentication callback mechanism. An authentication request 501 is sent by the response processor component 408, previously shown in FIG. 4, of the request handler 502, which is the same as request handler 106 in FIG. 1, via server computer 503, which is the same as server computer 103 in FIG. 1, to an authentication computer 504, over a network 505, which may or may not be the same as network 104 in FIG. 1.

The authentication request 501 is received by the authentication computer 504, which passes it on to an authentication process 506. The authentication process 506 consults an authentication data file 507, and depending on the result, sends one of several types of authentication responses 508 back to request handler 502 over network 505, via authentication computer 504 and server computer 503. Request handler 502 evaluates authentication response 508 and, based on the authentication response, produces the response 109 shown in FIG. 1. Thus, the request is authenticated before a response is sent back.

Authentication computer 504 is one of the following, and may or may not be the same as server computer 103 shown in FIG. 1, and may or may not be the same as client computer 101 shown in FIG. 1:
A server computer.
A personal computer.
A handheld or wireless computer.
A mobile device, such as a cell phone, a wireless email device or PDA.
An embedded device, such as an embedded control unit, or smart card or RFID card or other embedded device.
Any other computing device, whether general-purpose or special-purpose that has sufficient computing resources and power (e.g., processor speed, memory space, etc.) to perform the functions and operations of the authentication computer 504.

The authentication computer 504, the authentication process 506, the authentication data file 507, or any information item held by authentication data file 507 may be identified and authorized through additional mechanisms such a host certificates, a public key infrastructure or a decentralized trust model (such as PGP or GPG).

The authentication request 501 is one or more of the following:
An HTTP GET request using zero or more of the parameters of request 102 previously shown in FIG. 1.
An HTTP POST request, using zero or more of the parameters of request 102 previously shown in FIG. 1.
An HTTP GET or POST request, also employing HTTP Cookies.
An encrypted version of such a request.
A request conveying substantially the same information using any other networking protocol.

The authentication process 506, having received authentication request 501, has the following behavior:
Read and parse authentication request 501.
Check that the clientid and clientcredtype parameters are recognized by this authentication process.

Check that the clientcred is currently valid according to the authentication process'definition of validity. Depending on the credential validation mechanism employed, such validation may include complex calculations and database lookups. The present invention may be used with a variety of algorithms.
Determine the result of the authentication check by checking whether all checks were successful. If all were successful, the result of the authentication check is success. Otherwise it fails.
Return the result as authentication response 508.

The authentication response 508 is one of the following:
the text string “true” or “false” in the body of the HTTP response.
an XML document containing a boolean value in the body of the HTTP response.
any other response that clearly identifies whether the authentication was successful or not.

The response processor 408 uses the following algorithm to construct response 409:
1. Check Authorization
   a. Determine client identity
      i. Use the value of the clientid parameter of request 405 as client identity, if
         1. the clientid parameter was provided as part of request 405, and
         2. the value of the clientid parameter is found or matched in authorization file 403, and
         3. either both clientcred and clientauthority parameters are provided as part of request 405, or authorization file 403 states that client credentials are not required for clients with this clientid, or for all clients.
      ii. Otherwise, use “undefined client” as the client identity.
   b. If the resulting client identity is not “undefined client”, and if request 405 contains the clientcred parameter
      i. if request 405 contains the clientauthority parameter, and if authorization file 407 states that the identified clientauthority is accepted as authentication provider,
         1. Send clientid, clientcred, clientcredtype parameters to the clientauthority.
         2. Authentication computer 504 consults authentication data file 507 to determine whether the credential provided (indirectly) by client is sufficient, and responds accordingly.
         3. If response from clientauthority authenticates client, accept clientid as authenticated client.
         4. If response from clientauthority does not authenticate client, set clientid to “undefined client”, respond to the user with an authentication error message, and abort.
      ii. if request 405 does not contain the clientauthority parameter, and if authentication file 407 does not state that authentication is not needed
         1. perform a local authentication against the information contained in authorization file 403 through authorization file parser 407.
         2. If local authentication succeeds, accept clientid as authenticated client.
         3. If local authentication fails, set clientid to “undefined client”, respond to the user with an authentication error message, and abort.
2. Determine data elements that client may access
   a. Use the information obtained from authorization file 403 through authorization file parser 407 to determine the groups of clients containing the authorized client identity, or “undefined client”.
   b. Use the information obtained from authorization file 403 through authorization file parser 407 to determine the data elements that the groups of clients containing the authorized client identity may access.
   c. Filter the information obtained from data file 402 through data file parser 406 according to the data element specification determined in the previous step.
   d. Construct an XML sub-tree with this information.
3. Select elements for response
   a. Intersect the XML sub-tree produced in the previous step with the XPath parameter of request 405
4. Format elements for response
   a. Format elements obtained in previous step into a response 409 according to the format parameter of request 405.
5. Send response.

In FIG. 6, an example is given for the data file 107, previously shown in FIG. 1. In the preferred embodiment of the present invention, the data file has the XML-based VCard format defined by the Jabber Software Foundation. As will be known by those skilled in the art, any other information structure that can be addressed through an expression can be employed without deviating from the principles and spirit of the present invention.

FIG. 7 is an example of an authorization file 108, previously shown in FIG. 1. It uses the example.com convention for domain names per RFP 2606.

FIG. 8 shows several examples 801-809 for request 102 previously shown in FIG. 1. Following good practice, the reserved and excluded characters “/” (% 2f), “[” (% 5b), “]” (% 5d) and “:” (% 3a) are escaped in the parameter values for the URIs.

FIGS. 9A-C show several examples 901-909 for the first fragment of response 109 for corresponding example requests 801-809, respectively, previously shown in FIG. 8.

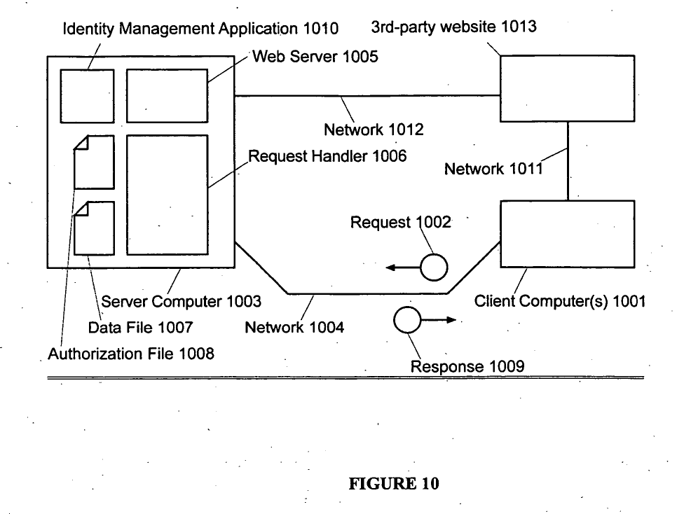

FIG. 10 shows the same aspects of the present invention as FIG. 1, but adds a third-party website 1013, a network 1011 that connects one or more client computer(s) 1001 with the third-party website 1013, and a network 1012 that connects client computer 1001 with server computer 1003. The networks 1011 and 1012 may or may not be the same as network 1004. Thus, the identity management system may be used in cooperation with third party websites, applications, other software or computing devices (all collectively called third-party website).

### EXAMPLE SCENARIOS

Now, a number of example scenarios are discussed that illustrate some aspects of the present invention. In these scenarios, the phrase “client enters URIr” shall mean: “a human or a machine takes an action that will cause a request for the URI in a browser or any other software running on client computer 101 as shown in FIG. 1”.

In example scenario 1, a client wishes to access the home page of the actor. The client enters the well-known URI of the actor. One example for such a request is item 801 in FIG. 8. The request handler decodes the parameters of the request, and finds none. The request handler determines that the client supports HTML. The request handler responds with a redirect to the actor's home page URI that it determines from the data file. The first part of the HTTP response is shown in item 901 in FIG. 9.

In example scenario 2, a client wishes to obtain all identity information for the actor. The client enters the well-known URI of the actor and specifies the root element using the xpath parameter. One example for such a request is item 802 in FIG. 8. The request handler decodes the parameters of the request, and only finds an XPath specification. The request handler determines the group of actors containing “undefined actor” in the authorization file. The request handler determines the protection domain that may be accessed by this group of actors by consulting the authorization file and constructs an XML sub-tree of the accessible items. The request handler intersects the current XML sub-tree with the XPath specification. The request handler determines that the client supports HTML. Given that no format has been specified, the request handler formats the current XML sub-tree as HTML, and responds with it. The first part of the response is shown as item 902 in FIG. 9.

Example scenario 3 is like scenario 2, except that the client requests that the response be formatted in XML (an example of which is shown as item 803 in FIG. 8). The request handler formats the XML sub-tree as valid XML and responds with it (an example of which is shown as item 903 in FIG. 9).

Example scenario 4 is like scenario 2, except that the XPath expression given as item 804 in FIG. 8, asks for just the E-Mail elements in the data file that have been marked as preferred. The request handler responds with the preferred E-Mail elements as HTML (an example of which is shown as item 904 in FIG. 9).

Example scenario 5 is like scenario 4, except that the client wishes to send email and so the format parameter has been set to “redirect”. This is shown as item 805 in FIG. 8. As a result, the request handler responds:
with an HTTP redirect to the value of the resulting XML element, if there is exactly one resulting XML element with a URI value (an example of which is shown as item 905 in FIG. 9)
with an HTTP redirect to the value of the first resulting XML element, if there is more than one resulting XML element with a URI value.
with an HTML error message and a document indicating an error if there is no resulting XML element.

In example scenario 6, a client wishes to obtain the preferred email address of the actor. The client enters the well-known URI of the actor with an XPath specification, and a clientid. One example for such a request is item 806 in FIG. 8. The request handler decodes the parameters of the request, and finds an XPath specification as well as a clientid, but no clientcred. The request handler determines the group of actors containing “clientid” in the authorization file. The request handler determines the protection domain that may be accessed by this group of actors and constructs an XML sub-tree with it. The request handler intersects the current XML sub-tree with the XPath specification. The request handler formats the current XML sub-tree as HTML, and responds with it. The first part of the response is shown as item 906 in FIG. 9.

In an alternate embodiment, the request handler determines that the client has not provided any credentials, and decides to ignore the clientid as it wants to protect against impersonation of one client by another.

In another embodiment, the request handler determines that the client has not provided any credentials, but that the authorization file specifies that this particular client, or a class of clients that this particular client belongs to, does not need to provide credentials, and continues as in the preferred embodiment.

In example scenario 7, a client wishes to obtain the preferred email address of the actor. The client enters the well-known URI of the actor with an XPath specification, a clientid, and a clientcred. One example for such a request is item 807 in FIG. 8. The request handler decodes the parameters of the request, and finds an XPath specification as well as a clientid, and a clientcred. The request handler determines the authentication provider through the clientauthority parameter, determines whether this authentication provider is trusted, and if so, sends to it a query, with clientid, clientcred and clientcredtype as a parameters, asking for validation. The authentication processor at this URI checks that clientid and clientcred are valid and responds with a positive. The request processor determines the group of actors containing “clientid” in the authorization file. The request handler determines the protection domain that may be accessed by this group of actors and constructs an XML sub-tree with it. The request handler intersects the current XML sub-tree with the XPath specification. The request handler determines that the client supports HTML. The request handler formats the current XML sub-tree as HTML, and responds with it. This is shown in item 907 in FIG. 7.

Example scenario 8 is like scenario 2, except that the XPath expression given as item 808 in FIG. 8, asks for the physical address elements in the data. The request handler responds with the address elements as HTML (an example of which is shown as item 908 in FIG. 9).

In example scenario 9, the client is using a smart phone and wishes to make a phone call to the actor's work phone. The smart phone, on behalf of the client, sends a request to the URI of the actor with an XPath specification and a format. The XPath statement given specifies work telephone information and the format given is XML (an example of which is shown as item 809 in FIG. 8). If the smart phone client desires, it can limit the search to only preferred telephone information. The request handler checks the authorization and applies the XPath statement. The request handler responds with the telephone information, including telephone number, formatted in XML (an example of which is shown as item 909 in FIG. 9). If information about only one telephone is returned, the smart phone then proceeds to make the phone call, otherwise the smart phone displays the information about the telephones for the client so the client can manually select which phone to call.

In example scenario 10, shown in FIG. 10, the actor operates a server computer 1003 which hosts web server 1005, request handler 1006, data file 1007, authorization file 1008 and identity management application 1010 to handle requests for his digital identities. The actor wishes to use client computer 1100 (which may or may not be the same as server computer 1003) to log into a third-party website 1013 that employs the present invention to handle user authentication and single-sign-on. In this scenario, the actor first logs into the identity management application to authenticate his browser session. Then, the actor accesses the third-party website and enters the URI of the request handler as the actor's user name at the third-party website. Actor does not need to enter a password or other credential, and the third-party website may even choose to store the actor's URI in a cookie with a long expiration time. From this point, the scenario executes in the same way the single-sign-on scenario described in the specifications of the Liberty Alliance executes. Network 1012 is the network carrying the “back channel” communication. Liberty calls the software running on the client computer 1001 “user agent”, the third-party website 1013 “service provider”, and the request handler 1006 the “identity provider”.

Example scenario 11 employs the present invention as part of a single-sign-on system. FIGS. 11-1, 11-2, 11-3, and 11-4 show the behavior of the present invention for such a single-sign-on system using sequence diagrams. In particular, the sequence diagrams illustrate the information sent and received between actor 1101, client computer 1102 which is the same as client computer 1001 in FIG. 10, third-party website 1103 which is the same as third-party website 1013 in FIG. 10, request handler 1104 which is the same as request handler 1006 in FIG. 10, and identity management application 1105 which is the same as identity management application 1010 in FIG. 10. This scenario employs the HTTPS protocol, including the checking of certificates, in order to protect against a variety of man-in-the-middle and other attacks. However, as it will be apparent to those skilled in the art, protocols other than HTTPS may be used without deviating from the principles and spirit of the present invention.

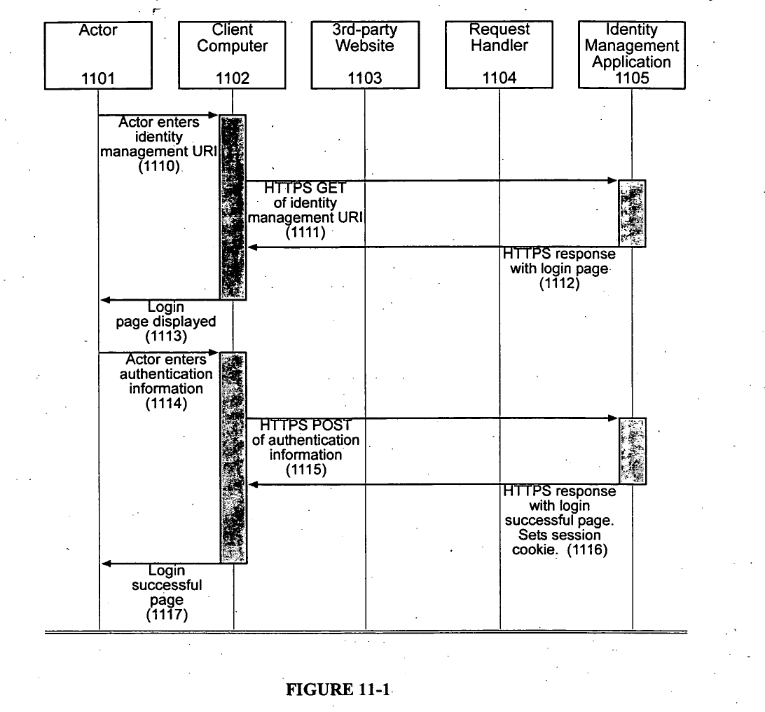

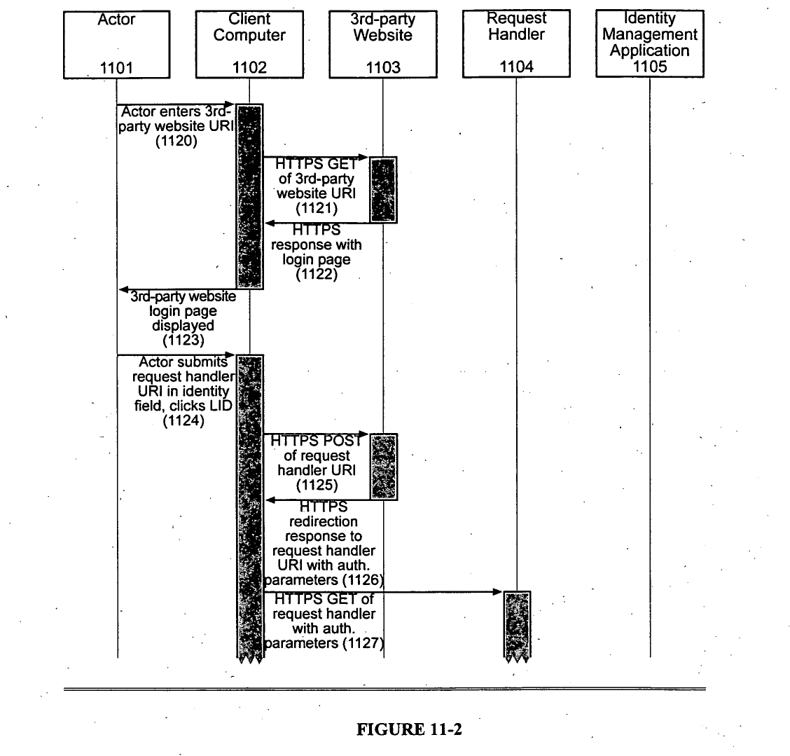

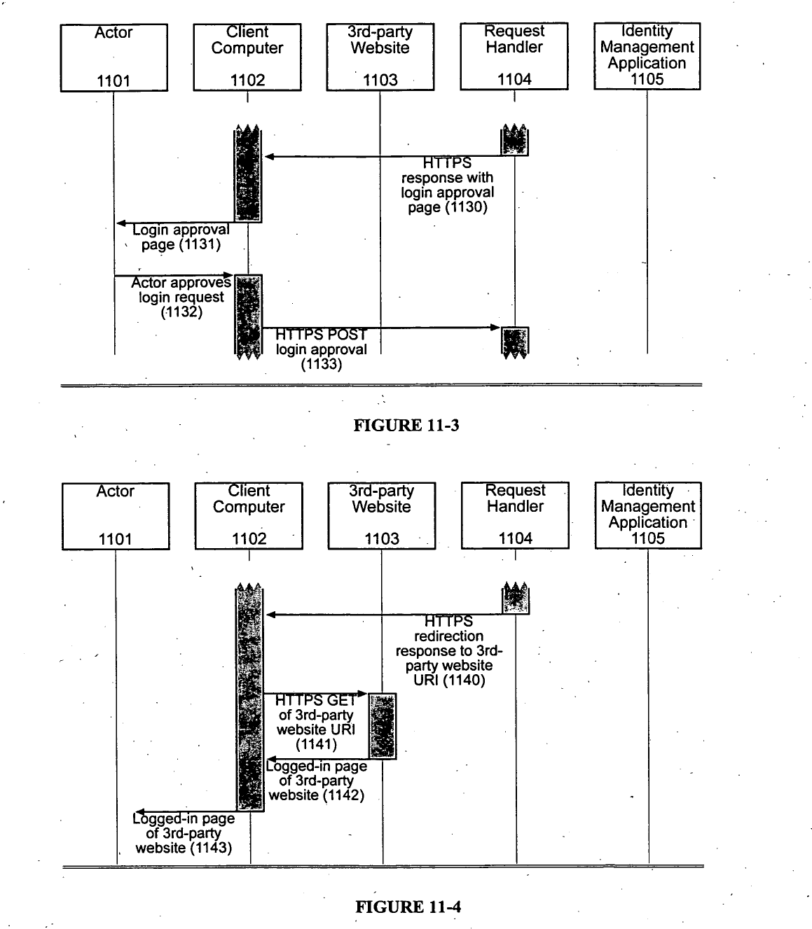

In the first step (shown in FIG. 11-1) of this example scenario, actor 1101 enters 1110 the URI of the identity management application into client computer 1102. As a result, client computer 1102 sends 1111 an HTTPS GET request to identity management application 1105. Identity management application 1105 responds 1112, using the HTTPS protocol, with a login page for the identity management application 1105, which is received by client computer 1102 and displayed 1113 by client computer 1102 to actor 1101. Actor 1101 then enters 1114 authentication information into the login page and submits the page, which causes client computer 1102 to issue 1115 an HTTPS POST command with the entered authentication information to identity management application 1105. Identity management application 1105 examines the provided authentication information, and if acceptable, identity management application 1105 responds 1116 with a login successful page, which is rendered and shown 1117 to actor by client computer 1102. As part of HTTPS response 1117, identity management application 1105 issues a session cookie to client computer 1102.

In the second step (shown in FIG. 11-2) of this example scenario, actor 1101 wishes to log into a third-party website 1103. To do this, actor 1101 enters 1120 the URI of the third-party website into client computer 1102. As a result, client computer 1102 sends 1121 an HTTPS GET request to the third-party website 1103. Third-party website 1103 responds 1122 with a login page, which is received by client computer 1102 and displayed 1123 to the actor 1101. Instead of entering a site-specific username and password, actor 1101 only enters the URI of the request handler 1104 into the displayed login page of third-party website 1103. As third-party website 1103 takes advantage of the present invention, it offers a special login button (here named “LID”). Actor submits 1124 the URI of the request handler by clicking on the button named “LID”, which causes client computer 1102 to issue 1125 an HTTPS POST command to third-party website 1103, which carries the URI of request handler 1104. Upon receiving the submitted URI of request handler 1104, third-party website 1103 responds 1126 with an HTTPS response with an HTTP redirect status code, redirecting to the URI of the request handler 1104 with parameters:
xpath: concatenation of a prefix (such as /accounts/) and the URI of request handler 1104
clientid: URI of third-party website 1103.

Having received this response 1126, client computer 1102 issues 1127 an HTTPS GET command on the URI of the request handler 1104 with the same parameters that were specified in response 1126.

Depending on the information found in data file 107 and authorization file 108, both previously shown in FIG. 1, the example scenario either executes or skips the following third step, as described previously.

If the third step (shown in FIG. 11-3) of the example scenario is executed, request handler 1104 responds to previously received 1127 HTTPS GET by sending 1130 a login approval page back to client computer 1102, which displays 1131 the received page to actor 1101. Said login approval page offers actor 1101 the following choices:
approve the login into this third-party website
reject the login into this third-party website
approve the login and future logins into the same third-party website (as identified by the parameters supplied in HTTPS GET request 1127) for some period of time, which may be infinite.

If actor 1102 rejects the login request, or actor does not submit the page, the scenario stops here and no login is performed at the third-party website 1103. If actor 1102 approves the login request, actor 1102 selects the appropriate option on client computer 1102, as a result of which client computer 1102 sends 1133 an HTTPS POST request with the said information to request handler 1104. Upon receiving said HTTPS POST, request handler 1104 may modify authorization file 108 by adding the information that future login requests by 3^{rd}-party website 1103 may succeed, within a currently authenticated browser session (per first step of this scenario), without human intervention.

In the fourth step (shown in FIG. 11-4), which takes place whether or not the third step has been executed, unless the execution of the scenario has been stopped during the execution of the third step, request handler 1104 responds 1140 with an HTTP redirect status code, redirecting to a URI that consists of the URI of the third-party website 1103, and the following parameters:
URI of request handler 1104.
URI of third-party website 1103.
status of the login request, which here is “approved”.
electronic signature, using any known method for creating such, of the said previous three parameters, with the private key of the authority that has the right to the URI of request handler 1104, in order to prevent spoof attacks. For example, this electronic signature may be created using the private key of the host on which request handler 1104 runs.

Upon receipt of HTTP redirection response 1140, client computer 1102 issues 1141 an HTTPS GET request to third-party website 1103, passing along the same parameters as provided by HTTP redirect 1140. Having received HTTPS GET request 1141, third-party website 1103 first checks the validity of the electronic signature provided as part of request 1141 using any method it chooses to be satisfactory (such as validating the certificate chain). If such validity check is not satisfactory to third-party website 1103, third-party website 1103 will not allow actor 1101 to log in and the execution of the scenario stops. If such validity check is satisfactory, third-party website 1103 responds 1142 with the logged-in page, indicating a successful login of actor 1101. Client computer 1102 receives response 1142 and displays 1143 the response to actor 1101, who is now successfully logged into third-party website 1103. Third-party website 1103 may repeat the same series of steps for each new information element shown to actor 1101 while interacting with third-party website 1103, or consider the session between third-party website 1103 and actor 1101 using client computer 1102 valid until actor 1101 logs out or the session times out. Third-party website 1103 may employ cookies to maintain such a session.

As those skilled in the art will know, not only third-party websites but many other kinds of software that require actor authentication, not only HTTPS but many different kinds of protocols, not only URIs but many other kinds of information representation may be employed without deviating from the principles and spirit of the present invention.

Example scenario 12 is identical to example scenario 10, except that third-party website 1013 (in FIG. 10) requests identity information not related to authenticating the actor at third-party website 1013. There are many applications of this scenario. For example, if the third-party website 1023 is an e-commerce website, this allows third-party website 1023 to obtain the actor's current credit card number to charge a purchase to that card. Alternatively, third-party website 1023 may obtain the actor's current account balance at a certain account using the same protocol. In this case, data file 107 would like be partially comprised of another party's (such as a bank's) information system as discussed previously.

The present invention may also be used to authenticate request handler 1006 (in the role as software running on the client computer) against the bank's information system (in the role as server computer and its constituent parts).

While the foregoing has been with reference to a particular embodiment of the invention, it will be appreciated by those skilled in the art that changes in this embodiment may be made without departing from the principles and spirit of the invention, the scope of which is defined by the appended claims.

1. An identity management system, comprising:
a first computer, used by a first actor, that connects over a network to a second computer that manages identity information of a second actor;
the first computer further comprising a software component that generates, on behalf of the first actor, a request for identity information about the second actor, the request being communicated to the second computer over the network, the request further comprising the identity of the first actor and a desired format for the identity information of the second actor to be returned in a response to the identity information request;
the second computer further comprising a request handler that receives the identity information request, a data file containing one or more pieces of information about the identity of the second actor and an authorization file containing information about one or more client groups and which actors are members in each client group, wherein membership in the client group is required to access a piece of identity information associated with that client group; and
wherein the information held by the data file and the authorization file changes dynamically during the operation of the system; and
wherein the request handler automatically generates a response, communicated over the network, containing identity information about the second actor in response to the identity information request based on the contents of the data file and of the authorization file at the time of the identity information request, wherein the response further comprises one or more pieces of identity information, in the requested format, about the second actor based on the client groups in which the first actor is a member.

2. The system of claim 1, wherein the second computer further comprises an identity management application that permits the second actor to create, read, and modify the data file and the authorization file of the second actor.

3. The system of claim 1 further comprising an authentication computer further comprising an authentication process and an authentication data file wherein the request handler generates an authentication request that is received by the authentication process and wherein the authentication process, based on the authentication data file, generates an authentication response that is communicated back to the request handler in order to authenticate the first actor that requests the identity information.

4. The system of claim 1, wherein the first actor and a third actor send the same request to the second computer and wherein the response to the first actor is different from the response to the third actor based on the client group memberships of the first actor and third actor.

5. The system of claim 1 further comprising a third party computer wherein the access to any components of the third party computer is managed by the second computer, without requiring the second actor to login in separately.

6. The system of claim 1, wherein the identity information request is submitted through a Uniform Resource Identifier (URI) that is specific to, under the control of and selected by the second actor.

7. The system of claim 6, wherein the URI is a uniform resource locator (URL) at a domain name selected by the second actor and served by a computer selected by the second actor.

8. The system of claim 1, wherein the response uses Extensible Markup Language (XML) format.

9. The system of claim 1, wherein the response uses Hypertext Markup Language (HTML) format.

10. The system of claim 1, where in the response uses a electronic business card (VCard) format.

11. The system of claim 6, wherein the URI is accessible using Hypertext Transfer Protocol (HTTP).

12. The system of claim 1, wherein the identity information request and the response are encrypted and digitally signed.

13. The system of claim 9, wherein the response further comprises a redirect command using the Hypertext Transfer Protocol (HTTP) protocol to a different Uniform Resource Identifier (URI).

14. The system of claim 1, wherein the authorization file is expressed in Extensible Markup Language (XML).

15. The system of claim 1, wherein the data file is expressed in Extensible Markup Language (XML).

16. The system of claim 1, wherein data file and authorization file are dynamically assembled at the time of the request from external information.

17. The system of claim 1 wherein the one or more pieces of identity information of the second actor further comprises one or more of a given name, middle and last name, a telephone number, an e-mail address, an instant messaging handle, a physical address, a Uniform Resource Identifier (URI), a photograph, a birthday, an organization, a title, a role and a public key.

18. The system of claim 1, wherein the identity information comprises identity information of the members of the second actor's social network.

19. The system of claim 1, wherein the identity information comprises the second actor's credentials for a plurality of 3^{rd}-party websites and software applications.

20. The system of claim 1, wherein the identity information comprises the second actor's location and presence status.

21. The system of claim 1, wherein the identity information request further comprises a query that identifies the one or more pieces of identity information of the second actor requested by the first actor and wherein the response comprises only the one or more pieces of requested identity information.

22. The system of claim 1 further comprising a plurality of second computers wherein each second computer accepts the same format for identity information requests.

23. The system of claim 1 further comprising a special identity request which causes the second computer to respond with a list of identity requests that it can satisfy.

24. The system of claim 21, wherein the query comprised by the identity request is an XML Path Language (XPath) expression.
